(19) United States
(12) Patent Application Publication
(10) Pub. No.: US 2023/0009807 A1
(43) Pub. Date: Jan. 12, 2023

(54) TEXT ENTRY METHOD AND MOBILE DEVICE

(71) Applicant: GUANGDONG OPPO MOBILE TELECOMMUNICATIONS CORP., LTD., Dongguan (CN)

(72) Inventors: Buyi XU, Palo Alto, CA (US); Yi XU, Palo Alto, CA (US)

(21) Appl. No.: 17/933,354

(22) Filed: Sep. 19, 2022

Related U.S. Application Data
(63) Continuation of application No. PCT/CN2021/087238, filed on Apr. 14, 2021.
(60) Provisional application No. 63/009,862, filed on Apr. 14, 2020.

(51) Int. Cl. G06F 3/04886; G06F 3/0485; G06F 3/0482; G02B 27/01

(52) U.S. Cl. CPC G06F 3/04886; G06F 3/0485; G06F 3/0482; G02B 27/017

(57) ABSTRACT

A text entry method, a mobile device, a head-mounted display, and a storage medium are provided in implementations of the present disclosure. The mobile device has an operation interface, and the operation interface includes a keyboard area and a control area. The method includes the following. A first operation instruction is received at the keyboard area. At least one candidate text is displayed in the control area. A second operation instruction is received at the control area. A target text is determined from the at least one candidate text according to the second operation instruction, and the target text is transmitted to a text entry interface of a head-mounted display (HMD) for display.

### CROSS-REFERENCE TO RELATED APPLICATION(S)

This application is a continuation of International Application No. PCT/CN2021/087238, filed Apr. 14, 2021, which claims priority to U.S. Provisional Application No. 63/009,862, filed Apr. 14, 2020, the entire disclosures of which are incorporated herein by reference.

### TECHNICAL FIELD

Implementations of the disclosure relates to the field of visual enhancement technology and particularly to a text entry method and a mobile device.

### BACKGROUND

In recent years, with the development of visual enhancement technologies such as virtual reality (VR), augmented reality (AR), and mixed reality (MR), a virtual three-dimensional world can be simulated through a computer system, which enables a user to interact with a virtual scene and brings the user an immersive experience.

Head-mounted displays (HMDs) may include a VR device, an AR device, an MR device, and the like. A text entry interface is a very challenging problem for the HMD. Typically, the text entry interface can be implemented by using a hand-held controller. However, this method is cumbersome, unfavorable to the input operation the user, and is inefficient. In addition, in some cases, although an existing text entry interface of a mobile device (such as a smart phone) can be used, this method also has disadvantages, such as requiring the user to look at a screen of the mobile device.

### SUMMARY

In a first aspect, a text entry method is provided in implementations of the present disclosure. The text entry method is applicable to a mobile device, the mobile device has an operation interface, and the operation interface includes a keyboard area and a control area. The method includes the following. A first operation instruction is received at the keyboard area. At least one candidate text is displayed in the control area, where the at least one candidate text is generated according to the first operation instruction. A second operation instruction is received at the control area. A target text is determined from the at least one candidate text according to the second operation instruction, and the target text is transmitted to a text entry interface of a head-mounted display (HMD) for display.

In a second aspect, a text entry method is provided in implementations of the present disclosure. The text entry method is applicable to an HMD, and the method includes the following. A text entry interface is displayed. A target text transmitted by a mobile device is received and the target text is input into the text entry interface.

In a third aspect, a mobile device is provided in implementations of the present disclosure. The mobile device includes a first memory and a first processor. The first memory is configured to store a computer program executable on the first processor. The first processor is configured to execute the method of any of the first aspect when running the computer program.

### BRIEF DESCRIPTION OF THE DRAWINGS

FIG. 1 is a schematic diagram of an application scenario of a visual enhancement system.

FIG. 2 is a schematic diagram of an application scenario of a text entry with a handheld controller provided in the related art.

FIG. 3 is a schematic flow chart of a text entry method provided in implementations of the present disclosure.

FIG. 4 is a schematic diagram of a layout of an operation interface provided in implementations of the present disclosure.

FIG. 5 is a schematic flow chart of a text entry method provided in other implementations of the present disclosure.

FIG. 6 is a schematic diagram of a layout of an operation interface provided in other implementations of the present disclosure.

FIG. 7 is a schematic flow chart of a text entry method provided in other implementations of the present disclosure.

FIG. 8 is a schematic diagram of a layout of an operation interface provided in other implementations of the present disclosure.

FIG. 9 is a schematic structural view of a mobile device provided in implementations of the present disclosure.

FIG. 10 is a schematic diagram of a hardware structure of a mobile device provided in implementations of the present disclosure.

FIG. 11 is a schematic structural view of an HMD provided in implementations of the present disclosure.

FIG. 12 is a schematic diagram of a hardware structure of an HMD provided in implementations of the present disclosure.

### DETAILED DESCRIPTION

In order to have a more detailed understanding of features and technical contents of implementations of the present disclosure, the implementations of the present disclosure will be described in detail below with reference to accompanying drawings. The appended accompanying drawings are for illustrative purpose only and are not intended to limit the implementations of the present disclosure.

Unless otherwise defined, all technical and scientific terms used herein have the same meanings as commonly understood by those skilled in the technical field. The terms used herein are intended to be illustrative rather than restrictive.

In the following description, “some implementations” are used to describe a subset of all possible implementations, but it can be understood that “some implementations” can be the same or different subsets of all possible implementations, and can be combined with one another without conflict. It should also be noted that the term “first\second\third” involved in implementations of the present disclosure is only used to distinguish similar objects, and does not represent a specific order of objects. It is understood that “first\second\third” may be interchanged in a particular order or priority when permitted to enable the implementations of the disclosure described herein to be implemented in an order other than that illustrated or described herein.

Before the implementations of the present disclosure are described in further detail, nouns and terms involved in implementations of the present disclosure will be described. The nouns and terms involved herein are suitable for the following explanations.

Augmented reality (AR) can enhance an image as viewed on a screen or other displays, and these images are produced by overlaying computer-generated images, sounds, or other data on a real-world environment.

Mixed reality (MR) not just overlays but anchors virtual objects to the real world and allows a user to interact with combined virtual/real objects.

A head-mounted display (HMD) is a display device worn on the head or as part of a helmet, and the HMD has a display optic in front of one eye or both eyes.

An optical see through HMD (OST-HMD) is a type of HMD that allows the user to see through the screen. In implementations of the present disclosure, most MR glasses belong to this type (e.g., HoloLens™, MagicLeap™, etc.). Another type of HMD is a video pass-through HMD.

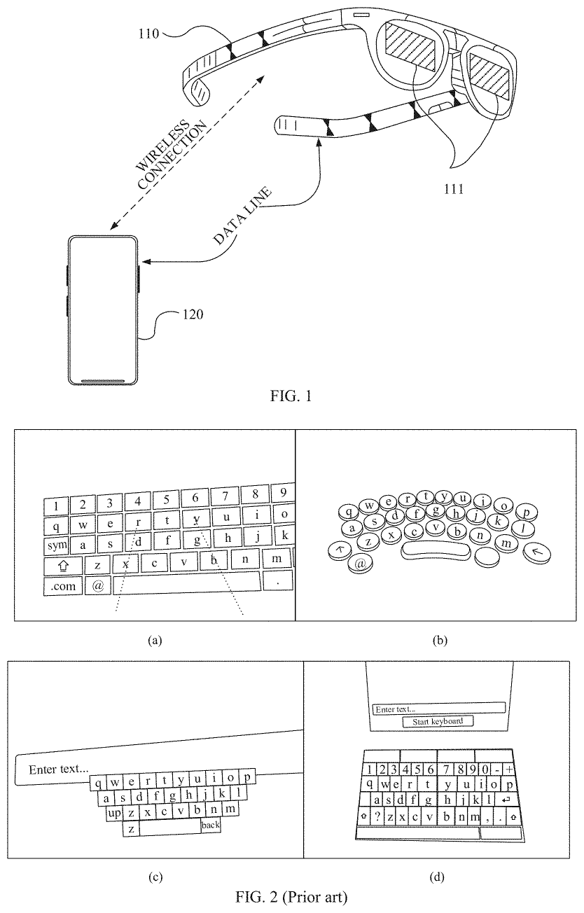

Reference is made to FIG. 1, which is a schematic diagram of an application scenario of a visual enhancement system. As illustrated in FIG. 1, the visual enhancement system 10 may include an HMD 110 and a mobile device 120. The HMD 110 and the mobile device 120 are connected with each other through wired or wireless communication.

The HMD 110 may refer to a monocular or binocular HMD, such as AR glasses. In FIG. 1, the HMD 110 may include one or more display modules 111 placed in an area close to one or both eyes of a user. Through the display module(s) 111 of the HMD 110, contents displayed therein can be presented in front of the user's eyes, and the displayed contents can fill or partially fill the user's field of vision. It should also be noted that the display module 111 may refer to one or more organic light-emitting diode (OLED) modules, liquid crystal display (LCD) modules, laser display modules, and the like.

Additionally, in some implementations, the HMD 110 may further include one or more sensors and one or more cameras. For example, the HMD 110 may include one or more sensors such as an inertial measurement unit (IMU), an accelerometer, a gyroscope, a proximity sensor, a depth camera, or the like.

The mobile device 120 may be wirelessly connected with the HMD 110 according to one or more wireless communication protocols (e.g., Bluetooth, wireless fidelity (WIFI), etc.). Alternatively, the mobile device 120 may also be wired to the HMD 110 via a data cable (e.g., a universal serial bus (USB) cable) according to one or more data transfer protocols such as USB. The mobile device 120 may be implemented in various forms. For example, the mobile device described in implementations of the present disclosure may include a smart phone, a tablet computer, a notebook computer, a laptop computer, a palmtop computer, a personal digital assistant (PDA), a smart watch, and the like.

In some implementations, the user of the mobile device 120 may control operations of the HMD 110 via the mobile device 120. Additionally, data collected by sensors of the HMD 110 may also be transmitted back to the mobile device 120 for further processing or storage.

It can be understood that in implementations of the present disclosure, the HMD 110 may include a VR device (e.g., HTC VIVE™, Oculus Rift™, SAMSUNG HMD Odyssey™ etc.) and an MR device (e.g., Microsoft Hololens™ 1&2, Magic Leap™ One, Nreal Light™, etc.). The MR device is sometimes referred to as AR glasses. A text entry interface is an important, yet very challenging problem for HMDs. Typically, the text entry interface is implemented by using a hand-held controller. However, such method is cumbersome and inefficient, especially when a text for entry is very long. Such method often leads to quick fatigue of the user because of large movements involved with moving the controller. An effective text entry interface is provided in implementations of the present disclosure.

There exist a few methods for text entry using hand-held controllers in the related art, four such methods of which will be described in detail with reference to FIG. 2.

a) Ray-casting. As illustrated in (a) of FIG. 2, in this popular method, text is input in an “aim and shoot” style. A user uses a virtual ray originated from a controller to aim at a key on a virtual keyboard. Key entry is confirmed with a click on a trigger button. The trigger button is typically on the back of the controller. This method can be done with either one hand or both hands can be used in this method.

b) Drum-like. As illustrated in (b) of FIG. 2, a user uses controllers like drumsticks on a virtual keyboard. A downward motion will trigger a key entry event.

c) Head-directed. As illustrated in (c) of FIG. 2, a user moves her/his head and uses a virtual ray originated from the HMD (representing a direction of a head) to point at the virtual keyboard. Key entry is confirmed by pressing a trigger button on the controller or a button on the HMD itself.

d) Split keyboard. As illustrated in (d) of FIG. 2, one virtual keyboard is assigned to each controller. Key selection is made by sliding a fingertip along a surface of a trackpad on the controller. Text entry is confirmed by pressing a trigger button.

The first two methods may lead to quick fatigue of the user because of large movements involved with moving the controllers. The third method involves moving the head and may increase the possibility of motion sickness of a user. Although the last method does not involve large motion of either hand or head, sliding fingertip to locate a key is inefficient when the keyboard has many keys.

Furthermore, a possible alternative is to introduce a circular keyboard layout with multi-letter keys, which can be operated by using one hand on a trackpad of a controller. The circular layout is consistent with a trackpad of a circular shape on some controllers for VR headset. This method has a letter selection mode and a word selection mode. For word selection, the method replies on usage frequencies of words in English language to give a user multiple choices of words based on a sequence of multi-letter keys. Although this method provides convenience of one-hand operation and does not lead to fatigue, it requires a user to learn a new keyboard layout. Besides, only using one hand will reduce the maximum input speed.

Furthermore, some other alternatives include speech techniques and mid-air typing with hand gesture pathing. The speech input is error-prone and does not afford privacy to a user. The mid-air typing relies on a camera, a glove or other devices for pathing gestures, and is also error-prone relatively and leads to fatigue of the user.

Furthermore, another alternative involves using an additional connected device for text entry, such as a method to use a smartwatch as an input device for smart glasses. For AR glasses that are tethered to a mobile device such as a smart phone (either via a USB cable or wirelessly using Bluetooth, WiFi, etc.), using an existing text entry interface of the mobile device is a simple or direct choice. Typically, a smartphone has a floating full keyboard (a QWERTY keyboard specifically), T9 predictive keyboard, a handwriting interface, etc. However, all these methods require a user to look at a keyboard interface on the screen of the mobile device. For MR/AR scenarios, the user might want to keep a virtual content or a physical world in her/his sight. In addition, in VR settings, the user may be unable to see the mobile device. Therefore, all of the above methods are not ideal.

Based on this, a text entry method is provided in implementations of the present disclosure. On the mobile device side, an operation interface of the mobile device includes a keyboard area and a control area. The mobile device receives a first operation instruction at the keyboard area, and displays at least one candidate text in the control area, where the at least one candidate text is generated according to the first operation instruction. The mobile device receives a second operation instruction at the control area, determines the target text from the at least one candidate text, and transmits the target text to a text entry interface of the HMD, where the target text is generated according to the second operation instruction. On the HMD side, the HMD displays the text entry interface, receives the target text transmitted by the mobile device, and inputs the target text into the text entry interface. In this way, since text entry for the HMD is realized through the operation interface of the mobile device, and the operation interface of the mobile device is divided into the keyboard area and the control area, an input operation can be performed with both hands to improve a typing speed, and the user does not need to look at the mobile device while typing, which can not only reduce the need for the user to move his/her eyes to watch a screen of the mobile device when using the mobile device as a text entry device, but also improve a text entry efficiency.

The implementations of the present disclosure will be described in detail below with reference to the accompanying drawings.

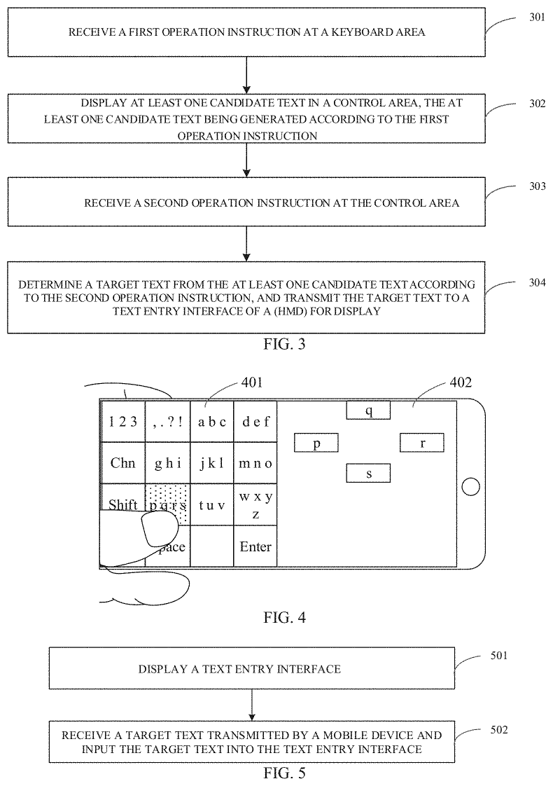

In an implementation of the present disclosure, and as illustrated in FIG. 3, which is a schematic flow chart of a text entry method provided in implementations of the present disclosure, the method may include the following.

At block 301, a first operation instruction is received at a keyboard area.

It should be noted that, in a text entry operation for an HMD, an operation interface of a mobile device (such as a smart phone) can be used as an operation interface of the HMD for text entry in the implementation of the present disclosure. In addition, the user can operate with two hands to increase the typing speed.

The operation interface displayed on a screen of the mobile device may include a keyboard area and a control area, so that the user can operate with both hands.

It should also be noted that the screen of the mobile device can be divided into two parts, including a left screen area and a right screen area. In some implementations, the method further includes the following. On the screen of the mobile device, the keyboard area is displayed in the left screen area, and the control area is displayed in the right screen area.

In other words, for the operation interface, in a specific example, the keyboard area may be displayed in the left screen area, and the control area may be displayed in the right screen area. In another specific example, the keyboard area may be displayed in the right screen area, and the control area may be displayed in the left screen area. Whether to display the keyboard area in the left area or the right screen area (or in other words, whether to display the control area in the left area or the right screen area) can be determined according to preferences of the user or other factors, which is not specifically limited in implementations of the present disclosure.

In addition, for the left screen area and the right screen area of the mobile device, the size of the left area and the size of the right area can be adjusted. In some implementations, the method may further include the following. The left area and the right area are resized based on a size of the screen of the mobile device and a size of a hand of the user.

It should be noted that the size of the left area and the size of the right area can be adaptively adjusted according to the size of the screen of the mobile device and the size of the hand of the user, and can even be adjusted according to preferences of the user, so as to make it more convenient for the user to operate.

In this implementation of the present disclosure, the keyboard area may include a virtual keyboard. The virtual keyboard may include at least one of the following according to differences in keyboard layouts: a circular layout keyboard, QWERTY keyboard, T9 keyboard, QuickPath keyboard, Swype keyboard, and a predefined keyboard.

QWERTY keyboard, also known as Curty keyboard or a full keyboard, is the most widely used keyboard layout. T9 keyboard is a traditional non-smart phone keyboard with relatively few keys, among which only numeric keys of 1 to 9 are commonly used, and each numeric key carries three pinyin, so as to realize a function of inputting all Chinese characters with 9 numeric keys. QuickPath keyboard, also known as a swipe keyboard, allows the user to input using gestures, and is commonly used in iOS devices. Swype keyboard is a touch keyboard that allows the user to type by gently swiping letters on the keyboard with his/her thumb or other fingers.

In addition, the predefined keyboard may be a keyboard different from QWERTY keyboard, T9 keyboard, QuickPath keyboard, and Swype keyboard, which can be customized according to requirements of the user. In this implementation of the present disclosure, the user can select a target keyboard from the above virtual keyboards according to actual needs, which is not limited herein.

It should also be noted that in this implementation of the present disclosure, the screen of the mobile device may be placed in a landscape orientation, so that the keyboard area and the control area are displayed on the screen of the mobile device side by side. Reference is made to FIG. 4, which is a schematic diagram of a layout of an operation interface provided in implementations of the present disclosure. As illustrated in FIG. 4, the screen of the mobile device is placed in the landscape orientation, and the operation interface (including the keyboard area 401 and the control area 402) is displayed on the screen of the mobile device. The screen of the mobile device is divided into two parts, the left area is the display keyboard area 401, in which a multi-letter keyboard layout similar to T9 keyboard is provided; the right area is the control area 402, in which at least one candidate text can be presented, such as p, q, r, s, etc.

At block 302, the at least one candidate text is displayed in the control area, where the at least one candidate text is generated according to the first operation instruction.

It should be noted that the virtual keyboard is placed in the keyboard area, and the first operation instruction herein may be generated by a touch-and-slide operation on the virtual keyboard performed by a finger of a user. In other words, in some implementations, the first operation instruction received at the keyboard area may include the following.

The at least one candidate text is generated according to a first touch-and-slide operation, upon detecting the first touch-and-slide operation on the virtual keyboard performed by the finger of the user.

The first operation instruction is generated according to the first touch-and-slide operation on the virtual keyboard performed by the finger of the user. In addition, after the at least one candidate text is generated, the at least one candidate text will be presented in the control area.

Specifically, if the user slides her/his finger in the keyboard area, one of multi-letter keys (which may also be referred to as “numeric keys”) may be selected. In a specific example, the finger of the user generally refers to a finger of the left hand of the user such as the thumb of the left hand, but may also be any other finger, which is not specifically limited in this implementation of the present disclosure.

In addition, the virtual keyboard is provided with multi-letter keys. In order to facilitate feedback of a key selected by the user, in a possible implementation, the method may further include: highlighting a key selected on the virtual keyboard upon detecting the first touch-and-slide operation on the virtual keyboard performed by a finger of a user.

In another possible implementation, the method may further include the following. Upon detecting that the finger of the user slides onto and touches a key on the virtual keyboard, the mobile device is controlled to vibrate.

In other words, if the mobile device detects that the finger of the user slides on keys on the virtual keyboard to select one of the multi-letter keys, the key selected can be highlighted on the screen of the mobile device for feedback, such as being differentiated by color. In addition to feedback of highlighting, other types of feedback can also be provided in implementations of the present disclosure, for example, when the finger of the user slides onto a multi-letter key, the mobile device vibrates. In addition, the operation interface of the mobile device can even be displayed in the HMD in implementations of the present disclosure, so as to feed back the selected key to the user.

In this way, once the first operation instruction is received in the keyboard area to determine the key selected, at least one candidate text will be presented in the control area according to the selected key. The candidate text may be letters/numbers, words, or Chinese characters, which are mainly related to an input mode.

In this implementation of the present disclosure, the keyboard area may be operable under multiple input modes. The multiple input modes may at least include a letter input mode and a word input mode, and may even include other input modes such as a Chinese character input mode. In some implementations, the method may also include the following.

A third operation instruction is received at the control area; and the keyboard area is controlled a to switch among the multiple input modes according to the third operation instruction.

In a specific implementation, the keyboard area can be controlled to switch among the multiple input modes according to the third operation instruction by controlling the keyboard area to switch among the multiple input modes upon detecting a double-tap operation in the control area performed by the finger of the user.

In other words, if the user uses a simple gesture, such as the double-tap in the control area (or, in the right area), in other words, the mobile device receives the third operation instruction, the mobile device can switch among these various input modes can be performed.

It can be understood that, for these various input modes, a corresponding relationship exist between candidate texts and the input modes, which will be described in the following by taking the letter input mode and the word input mode as examples respectively.

In a possible implementation, when the input mode is the letter input mode, the at least one candidate text can be displayed in the control area as follows.

A key in the keyboard area selected by the finger of the user is determined, upon detecting the first touch-and-slide operation on the virtual keyboard performed by the finger of the user. At least one candidate letter is displayed in the control area according to the key selected.

Further, in order to facilitate feedback of the key selected by the user, in a specific implementation, the method may further include highlighting the key selected.

In other words, in the letter input mode, the user can slide her/his thumb of the left hand (or any finger of her/his choice) across the keyboard area to select one of the multi-letter keys. The key selected can be highlighted on the mobile device screen for feedback. In addition, other types of feedback may also be provided in this implementation of the present disclosure, for example, when a new key is swiped onto, the mobile device vibrates.

In another possible implementation, when the input mode is the word input mode, the at least one candidate text can be displayed in the control area as follows.

A slide path of the finger of the user in the keyboard area is determined upon detecting the first touch-and-slide operation on the virtual keyboard performed by the finger of the user. At least one candidate word is displayed in the control area according to the slide path.

Further, in some implementations, the at least one candidate word is displayed in the control area according to the slide path as follows.

At least one key is determined to be selected, upon detecting in the slide path that a residence time of the finger of the user on the at least one key is longer than a first time. The at least one candidate word is generated according to a sequence of the at least one key in the slide path, and the at least one candidate word is displayed in the control area.

It should be noted that, in some implementations, when the same letter key is repeatedly typed, the method may further include the following.

A key is determined to be repetitively selected, upon detecting in the slide path that a residence time of the finger of the user on the key is longer than a second time. Alternatively, the key is determined to be repetitively selected, upon detecting in the slide path that the finger of the user holds on the key and the finger of the user performs a tap operation in the control area. The key is any key on the virtual keyboard.

It should also be noted that the first time and the second time may be different. The first time is used to determine whether a key is selected in the slide path, and the second time is used to determine whether a key is repetitively selected in the slide path.

In other words, in the word input mode, the virtual keyboard in the keyboard area is operated similarly to similar to QuickPath keyboard on iOS devices and Swype keyboard on Android devices. On Swype keyboard, instead of individual taps, the user can slide the finger onto each letter of a word without lifting the finger. An algorithm for determining a letter key selected may then be implemented, for example, by detecting a pause during a path. In this implementation of the present disclosure, the user can slide the thumb of the left hand to slide over the virtual keyboard, and then a set of candidate words matching a sequence of selected keys can be displayed in the control area.

Taking “app” as an example, “a”, “p”, and “p” need to be tapped, which involves typing the same letter key repeatedly, then the user can hold on the letter key and pauses briefly; and alternatively, the user can also use the thumb of the right hand to quickly tap the control area to confirm input of a repetitive key.

In addition, foreign language entry is also supported in implementations of the present disclosure, such as a Chinese character input mode. In some implementations, when the input mode is the Chinese character input mode, the at least one candidate text may be displayed in the control area as follows.

A slide path of the finger of the user in the keyboard area is detected upon detecting the first touch-and-slide operation on the virtual keyboard performed by the finger of the user. At least one candidate Chinese character is displayed in the control area according to the slide path.

In this implementation of the present disclosure, the Chinese character input mode is similar to the word input mode. In a specific example, Chinese characters can be entered as words that are composed of English letters by using a variety of schemes (e.g., Pinyin). Therefore, Chinese text entry can also be implemented with the word input mode.

In this way, after receiving the first operation instruction at the keyboard area, the mobile device can generate at least one candidate text (such as letters, words, Chinese characters, etc.) according to the first operation instruction, and then present the at least one candidate text in the control area, so as to further determine the target text to be input.

At block 303, a second operation instruction is received at the control area.

At block 304, the target text is determined from the at least one candidate text, and the target text is transmitted to the text entry interface of the HMD, where the target text is generated according to the second operation instruction.

It should be noted that, selection of the target text may be determined according to the second operation instruction at the control area received by the mobile device. The second operation instruction may be generated by a touch-and-slide operation of the finger of the user in the control area.

In some implementations, receiving the second operation instruction at the control area and determining the target text from the at least one candidate text includes the following.

The target text is determined from the at least one candidate text according to a slide direction of a second touch-and-slide operation, upon detecting the second touch-and-slide operation in the control area performed by the finger of the user, where the second operation instruction is generated according to the second touch-and-slide operation in the control area performed by the finger of the user.

Specifically, if the user slides her/his finger in the control area, the target text can be selected. In a specific example, the finger of the user here generally refers to a finger of the hand of the user which may be the thumb of the right hand, and may also be any other finger, which is not specifically limited in implementations of the present disclosure.

It should also be noted that, for the at least one candidate text displayed in the control area, the target text may be selected based on a slide gesture (specifically, a slide direction) of the user on the right screen area. As illustrated in FIG. 4, four candidate texts, such as p, q, r, and s, are presented in the control area. Letter q is displayed on the upper side and can be selected and confirmed by swiping upward. Letter r is displayed on the right and can be selected and confirmed by swiping to the right. Letter p is displayed on the left and can be selected and confirmed by swiping to the left. Letter s is displayed on the lower side and can be selected and confirmed by swiping down.

Furthermore, in some implementations, the method may further include the following. If the number of the at least one candidate text is only one, the target text is determined according to the second operation instruction, upon detecting a swipe in any direction in the control area performed by the finger of the user, or detecting a single tap in the control area performed by the finger of the user.

In other words, if there is only candidate text, that is, when a function key such as Backspace, Space, or Enter is selected, only one candidate text is available in the control area at this time. The target text to be entered can be selected and confirmed by a swipe in any direction or a single tap.

It will also be understood that only a finite number of directional options can be displayed in the control area. For example, a four-direction (up, down, left, and right) layout can be used to enable selection among four candidate texts. In addition, a six-direction layout, and an eight-direction layout, etc. are also possible, which depends on preferences of the user and the capability of the mobile device to distinguish among swipe directions, which are not specifically limited in implementations of the present disclosure.

If the number of the at least one candidate text exceeds the number of available directions, two buttons can also be set in the control area, including the first button and the second button, to switch display among multiple sets of candidate texts.

In some implementations, the method may also include the following. A fourth operation instruction is received at the control area. According to the fourth operation instruction, the control area is controlled to perform display switching among multiple sets of candidate texts.

In a specific implementation, the control area includes a first button and a second button, and according to the fourth operation instruction, the control area may be controlled to switch display among the multiple sets of candidate texts according to the fourth operation instruction as follows. The control area is controlled to switch display among the multiple sets of candidate texts upon detecting a tap operation on the first button or the second button in the control area performed by the finger of the user.

In another specific implementation, the control area may be controlled to switch display among multiple sets of candidate texts according to the fourth operation instruction as follows. The control area is controlled to switch display among the multiple sets of candidate texts upon detecting a third touch-and-slide operation towards the first button or the second button in the control area performed by the finger of the user.

The first button is configured to trigger display of the at least one candidate text to be updated to a next set, and the second button is used to trigger display of the at least one candidate text to be updated to a previous set.

It should be noted that, in this implementation of the present disclosure, two buttons i.e., “next” button and “previous” button, may be displayed at the bottom of the control area. At this time, a simple tap on “next” button or “previous” button allows the user to browse multiple sets of candidate texts.

It should also be noted that the user can also simply swipe in a direction towards a button to trigger previous sets of candidate texts and next sets of candidate texts. For example, slide directions of “bottom-left diagonal” and “bottom-right diagonal” are reserved for browsing multiple sets of candidate texts, while slide directions of “up”, “down”, “left”, and “right” are used to select the target text. In a specific example, “previous” button is located in the lower left corner of the control area, and “next” button is located in the lower right corner of the control area. When the finger of the user slides toward “previous” button in the control area (for example, swipe along the bottom-left diagonal direction), candidate texts of previous sets of the current set can be browsed. When the finger of the user slides toward “next” button in the control area (for example, swipe along the bottom-right diagonal direction), candidate texts of next sets of the current set can be browsed.

Further, the at least one candidate text may also be set in a list form. In some implementations, the method may also include the following. The at least one candidate text is set to a scrollable list. A candidate text in the scrollable list is controlled to be scrolled and displayed according to a slide direction of a fourth touch-and-slide operation, upon detecting the fourth touch-and-slide operation in the control area performed by the finger of the user.

It should be noted that, for the word input mode or the Chinese character input mode, a large number of candidate texts are presented in the control area. For convenience of selection, the at least one candidate text can be set to a scrollable list. The user can swipe up or swipe down to scroll the list and one candidate text in the list are highlighted. A text highlighted can be selected and confirmed as the target text for input by different swipe motions.

It should also be noted that the list can be a vertical list or a circular list. In addition, a display order of these candidate texts in the list can be determined according to preferences of the user, or can be determined in other ways. For example, the display order of words can be based on the frequency of the words in an English corpus (for example, the word with the highest frequency is displayed at top), which is not limited in implementations of the present disclosure.

Furthermore, in this implementation of the present disclosure, if the same letter key needs to be typed repeatedly (e.g., for “app”, “a”, “p”, and “p” need to be typed), the user can hold on the letter key and pauses briefly; and alternatively, the user can also use the thumb of the right hand to quickly tap the control area to confirm input of a repetitive key.

In addition, in this implementation of the present disclosure, glove-based or camera-based gesture recognition can also be used to implement mid-air typing in a similar manner, and then the target text can be transmitted to the text entry interface of the HMD.

In short, since the screen of the mobile device is divided into two parts, which are used to display the keyboard area and the control area and can be operated with both hands, it is convenient for the user to input text on the HMD which is tethered to the mobile device and an operating interface for a new computing device can be implemented by using elements that the user is already familiar with. In this way, in the operation interface of the mobile device, onboarding time of the user can be shortened by using elements that the user is already familiar with, such as a multi-letter keyboard layout similar to the familiar T9 keyboard.

A text entry method is provided in implementations. The text entry method is applicable to the mobile device. The operation interface of the mobile device includes the keyboard area and the control area. The mobile device receives the first operation instruction at the keyboard area, and displays the at least one candidate text in the control area, where the at least one candidate text is generated according to the first operation instruction. The mobile device receives the second operation instruction at the control area, determines the target text from the at least one candidate text, and transmits the target text to the text entry interface of the HMD, where the target text is generated according to the second operation instruction. In this way, since text entry for the HMD is realized through the operation interface of the mobile device, and the operation interface of the mobile device is divided into the keyboard area and the control area, an input operation can be performed with both hands to improve the typing speed, and the user does not need to look at the mobile device while typing, which can not only reduce the need for the user to move his/her eyes to watch the screen of the mobile device when using the mobile device as the text entry device, but also improve the text entry efficiency.

In another implementation of the present disclosure, reference is made to FIG. 5, which is a schematic flow chart of a text entry method provided in other implementations of the present disclosure. As illustrated in FIG. 5, the method may include the following.

At block 501, a text entry interface is displayed.

At block 502, a target text transmitted by a mobile device is received and the target text is input into the text entry interface.

It should be noted that the target text is determined according to touch-and-slide operations on the keyboard area and the control area of the mobile device respectively received by the mobile device performed by the finger of the user.

It should also be noted that, in the text entry operation on the HMD, an operation interface of the mobile device (such as a smart phone) can be used as the operation interface of the HMD for text entry in this implementation of the present disclosure. After the user operates on the mobile device, the target text can be transmitted to the HMD, and then synchronized to the text entry interface of the HMD for display.

In order to avoid a situation that users need move their eyes to watch a screen of the mobile device when using the mobile device as a text entry device, the operation interface of the mobile device may be displayed in the HMD in the implementation of the present disclosure, so as to provide feedback of operations of the user. In some implementations, the method may further include the following. An operation interface of the mobile device is displayed in the HMD. Correspondingly, the target text transmitted by the mobile device can be received by receiving the target text transmitted by the mobile device according to a response of the mobile device to the operation interface.

It should be noted that, through a display module of the HMD, the operation interface and the text entry interface of the mobile device can be displayed. When the operation interface of the mobile device is focused on, the operation interface of the mobile device can be displayed, and then the user performs touch operations on the operation interface of the mobile device, so as to determine the target text and input it into the text entry interface of the HMD synchronously.

It should also be noted that the operation interface presented in the HMD is consistent with the operation interface presented by the mobile device itself. The operation interface may include a keyboard area and a control area, and the keyboard area includes a virtual keyboard. Thus, in some implementations, the operation interface of the mobile device can be displayed by displaying the keyboard area and the control area in the HMD, and highlighting a selected key on the virtual keyboard.

Furthermore, in some implementations, the method may further include displaying a position of the finger of the user on the virtual keyboard with a preset indication.

In other words, in this implementation of the present disclosure, the keyboard area and the control area may also be displayed in the HMD. Since the keyboard area includes the virtual keyboard, and the virtual keyboard is provided with multi-letter keys, both the virtual keyboard and the multi-letter keys can be displayed in the HMD. When the finger of the user touches and slides on the mobile device to select one of multi-letter keys, on the one hand, the key selected can be displayed and highlighted on the screen of the mobile device, and on the other hand, the key selected can also be displayed and highlighted in the HMD. In addition, in order to facilitate feedback, the finger of the user may also be displayed in the HMD with a preset indication, so as to indicate the current position of the finger of the user.

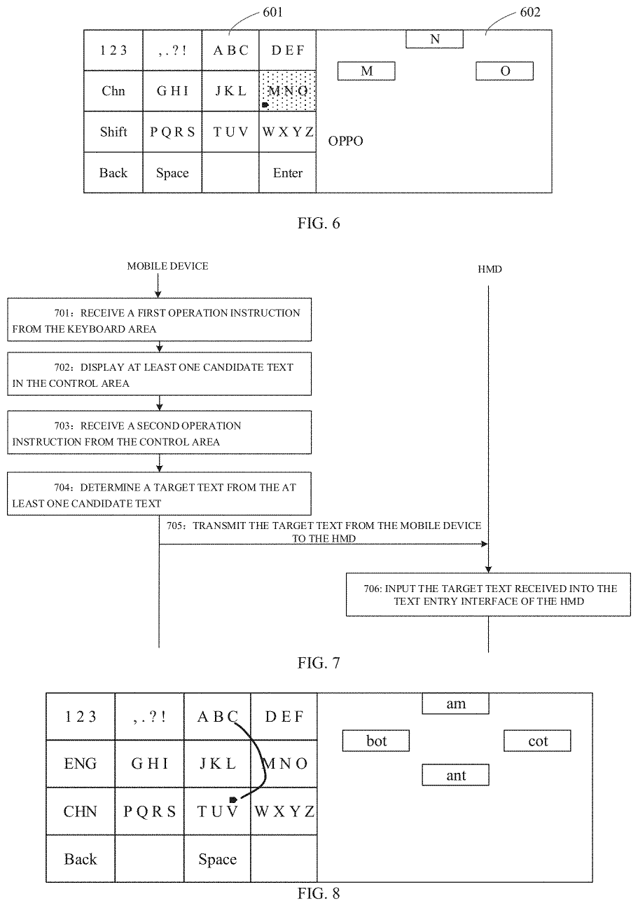

For example, reference is made to FIG. 6, which is a schematic diagram of a layout of an operation interface provided in other implementations of the present disclosure. As illustrated in FIG. 6, the operation interface (including the keyboard area 601 and the control area 602) is displayed in the HMD. When the finger of the user touches and slides on the mobile device to select “MNO” key, in the display module of the HMD, the key can also be highlighted on the virtual keyboard in the keyboard area 601, and the indication representing the position of the finger of the user (e.g., a black dot illustrated in FIG. 6) is displayed on the virtual keyboard at the same time.

It should also be noted that when at least one candidate text is presented in the control area of the mobile device, in the display module of the HMD, the at least one candidate text will be presented simultaneously in the control area 602. In order to facilitate the user to determine a slide direction of his/her finger, in some implementations, the method may further include the following.

A slide direction of the finger of the user is determined according to at least one candidate text displayed in the control area, where the slide direction indicates selecting a target text through a touch-and-slide operation on the operation interface of the mobile device performed by the finger of the user.

In other words, according to the at least one candidate text presented in the control area, the slide direction of the finger of the user can be determined, and then the user can perform the touch-and-slide operation with his/her finger. Exemplarily, still as illustrated in FIG. 6, letter “N” is located on the upper side of the control area, letter “N” is selected and confirmed as the target text by swiping upward; letter “M” is displayed on the left side, letter “M” is selected and confirmed as the target text by swiping to the left; letter “O” is displayed on the right side, letter “M” is selected and confirmed as the target text by swiping to the right. In this way, the user can use both hands collectively to input letters, for example, using the left hand to select letter keys in the keyboard area, and using the right hand to select the target text in the control area.

In this way, after the target text is determined, the HMD can focus on displaying the text entry interface, and synchronize the target text to the text entry interface for display.

A text entry method is provided in implementations. The text entry method is applicable to the HMD. The HMD displays the text entry interface, receives the target text transmitted by the mobile device, and inputs the target text into the text entry interface. In this way, since text entry for the HMD is realized through the operation interface of the mobile device, and the operation interface of the mobile device is divided into the keyboard area and the control area, an input operation can be performed with both hands to improve a typing speed, and the user does not need to look at the mobile device while typing, which can not only reduce the need for the user to move his/her eyes to watch a screen of the mobile device when using the mobile device as a text entry device, but also improve a text entry efficiency.

In another implementation of the present disclosure, as illustrated in FIG. 7, which is a schematic flow chart of a text entry method provided in other implementations of the present disclosure, the method may include the following.

At block 701, a first operation instruction is received at a keyboard area.

At block 702, at least one candidate text is displayed in the control area, where the at least one candidate text is generated according to the first operation instruction.

At block 703, a second operation instruction is received at the control area.

At block 704, a target text is determined from the at least one candidate text.

It should be noted that at least one candidate text is generated according to the first operation instruction, and the target text is generated according to the second operation instruction.

It should also be noted that operations at block 701 to block 704 are executed by the mobile device. After the mobile device determines the target text, and then the mobile device transmits the target text to an HMD for input.

At block 705, the target text is transmitted by the mobile device to the HMD.

At block 706, the target text received is input into the text entry interface of the HMD.

In this implementation of the present disclosure, the method is applicable to a visual enhancement system. In the visual enhancement system, the visual enhancement system may include the mobile device and the HMD. A wired communication connection can be established between the mobile device and the HMD through a data cable, and a wireless communication connection can also be established through a wireless communication protocol.

The wireless communication protocol may include at least one of the following: a Bluetooth protocol, a wireless fidelity (WiFi) protocol, an infrared data association (IrDA) protocol, and a near field communication (NFC) protocol. According to any kind of wireless communication protocols, the wireless communication connection between the mobile device and the HMD can be established for data and information exchange.

It should also be noted that, in implementations of the present disclosure, the mobile device is used as an operation interface and a method for text input for the HMD (such as AR glasses). As illustrated in FIG. 4, the screen of the mobile device is divided into two parts, where the left screen area is used to display the keyboard area, which can be a multi-letter keyboard layout similar to T9 keyboard; and the right screen area is used to display the control area, where the user can select among multiple numbers, letters, words, or Chinese characters. Therefore, a two-hand operation can be performed by the user to improve the typing speed; and while typing, the user does not need to use sense of sight on the screen of the mobile device, that is, “touch typing” can be achieved (that is, the user does not need to look at the screen of the mobile device).

In this implementation of the present disclosure, the keyboard area may include a virtual keyboard, and the virtual keyboard further includes multi-letter keys. The virtual keyboard may include at least one of the following according to differences in keyboard layouts: a circular layout keyboard, QWERTY keyboard, T9 keyboard, QuickPath keyboard, Swype keyboard, and a predefined keyboard.

Taking the letter input mode as an example, in the letter input mode, the user can slide her/his thumb of the left hand (or any finger of her/his choice) across the keyboard area to select one of the multi-letter keys. The key selected can be highlighted on the screen of the mobile device for feedback. In this implementation of the present disclosure, other types of feedback may also be provided, for example, when a new key is swiped onto, the mobile device vibrates. The operation interface (including the keyboard area and the control area) can also be displayed in the HMD, and corresponding keys can also be highlighted in the HMD. In addition, some indications (e.g., black dots) indicating the position of the finger of the user can also be displayed on the virtual keyboard of the HMD, as illustrated in FIG. 6.

Furthermore, for each letter key, a corresponding set of letters will be correspondingly displayed in the right area (i.e., the control area). The user can use a swipe gesture in the control area to select the target text (a letter in particular herein). For example, in FIG. 6, letter “N” is displayed on the upper side of the control area and will be selected and confirmed as the target text by swiping up and input into the text entry interface of the HMD. In this way, two hands can be used collectively to input letters in implementations of the present disclosure. However, if only one selection is available in the control area (e.g. a function key such as Backspace, Space, Enter, etc.), the target text can be selected and determined by a swipe in any direction or a single tap, and input into the text entry interface of the HMD.

It should also be noted that the keyboard area is also operable under the word input mode. Simple gestures (e.g., double tapping in the right screen area) can be used to switch between two input modes.

Taking the word input mode as an example, the virtual keyboard in the keyboard area is operated similarly to QuickPath keyboard on iOS devices and Swype keyboard on Android devices. On Swype keyboard, instead of individual taps, the user can slide the finger onto each letter of a word without lifting the finger. An algorithm for determining an intended letter may then be implemented, for example, by detecting a pause during the path. In this implementation of the present disclosure, the user can slide the thumb of the left hand to over the virtual keyboard, and then a set of candidate words matching a sequence of selected keys can be displayed in the control area. For example, reference is made to FIG. 8, which is a schematic diagram of a layout of an operation interface provided in other implementations of the present disclosure. As illustrated in FIG. 8, the operation interface may be displayed in an HMD and/or a mobile device. When the key sequence of ABC, MNO, and TUV is determined, words such as “am”, “bo”, “cot”, “ant”, etc. are displayed in the control area, such as the right area of the HMD and/or the right screen area of the mobile device. In addition, in the HMD, an indication indicating the position of the finger of the user (such as a black dot in FIG. 8) may also be displayed. Then, a directional swipe on the control area can select/confirm a word and the word is input into the text entry interface of the HMD.

In addition, foreign language entry is also supported in implementations of the present disclosure, such as a Chinese character input mode. In a specific example, Chinese characters can be entered as words that are composed of English letters by using a variety of schemes (e.g., Pinyin). Therefore, Chinese text entry can also be implemented with the word input mode.

In some implementations, if the same letter key needs to be typed repeatedly (for example, for “app”, “a”, “p”, and “p” need to be typed), the user can hold on the letter key and pauses briefly; and in other implementations, the user can also use the thumb of the right hand to quickly tap the control area to confirm input of a repetitive key.

Only a finite number of directional options can be displayed in the right area. For example, a four-direction (up, down, left, and right) layout can be used to enable selection among four candidate words. In addition, a six-direction layout, and an eight-direction layout, etc. are also possible, which depends on preferences of the user and the capability of the mobile device to distinguish among swipe directions. However, if the number of possible words exceeds the number of available directions, two buttons “next” button and “previous” button can be displayed at the bottom of the right area. At this time, a simple tap on “next” button or “previous” button allows the user to browse multiple sets of possible words. In another implementation, a simple swipe in a direction toward these two buttons can also trigger display of the previous sets of words and next sets of words (e.g., a bottom-left diagonal direction and a bottom-right diagonal direction are reserved for browsing word sets while swiping upward, swiping to the left, swiping to the right are used to select the target word).

It should also be noted that, in yet another implementation, these multiple possible words may also be implemented as a scrollable list. The user can swipe up or swipe down to scroll the list and a word in the list is highlighted. Additionally, the word highlighted can be selected and confirmed by a different swipe motion (e.g., swipe to the right) to be input into the text entry interface of the HMD. The list involved herein can be a vertical list or a circular list, and a display order of words in the list can be determined based on the frequency of the words in an English corpus. For example, the word with the highest frequency is displayed at top of the list.

Additionally, in other implementations of the present disclosure, the virtual keyboard in the keyboard area can have different layouts, such as a circular layout, or even a traditional QWERTY keyboard layout. In one implementation, the left area and the right area are resized based on a size of the screen and a size of a hand of the user. In another implementation, function keys such as Backspace, Space, Enter, etc. can be placed in the right area. Then, the function keys can be entered by simply sliding in a direction toward the function keys. In yet another implementation, in the word input mode, the user can also confirm selection and input of letter keys by clicking on the right side instead of instead of using Swype keyboard

In other implementations of the present disclosure, glove-based or camera-based gesture recognition can also be used to implement mid-air typing in a similar manner, and then the target text can be transmitted to the text entry interface of the HMD.

In this way, since the screen of the mobile device is divided into two parts to display the keyboard area and the control area respectively, so that both hands can be used for operation, thereby improving the input efficiency. Additionally, a multi-letter keyboard layout with a small number of keys can also be used, and the user does not need to use senses of sight all the time on the mobile device, which is impossible in VR). Instead, the user can continue to keep virtual contents or the real world in his/her sight, which is more desirable in the case of MR/AR). In addition, in the keyboard area, the multi-letter keyboard layout is similar to T9 keyboard users have been already familiar with, which also shortens onboarding time of the user.

A text entry method is provided in implementations of the present disclosure. A specific implementation of the foregoing implementations is described in detail with reference to the foregoing implementations. As can be seen from that, since text entry for the HMD is realized through the operation interface of the mobile device, and the operation interface of the mobile device is divided into the keyboard area and the control area, an input operation can be performed with both hands to improve a typing speed, and the user does not need to look at the mobile device while typing, which can not only reduce the need for the user to move his/her eyes to watch the screen of the mobile device when using the mobile device as a text entry device, but also improve a text entry efficiency.

This implementation provides a text input method. It can be seen from the above that, since the text entry for the HMD is realized through the operation interface of the mobile device, and The operation interface of the mobile device is divided into a keyboard area and a control area, so that you can input operations with both hands to improve the typing speed, and the user does not need to look at the mobile device when typing, which not only reduces the need for users to use the mobile device as a text input device. Move your eyes to watch the screen of a mobile device, and also improve the efficiency of text entry.

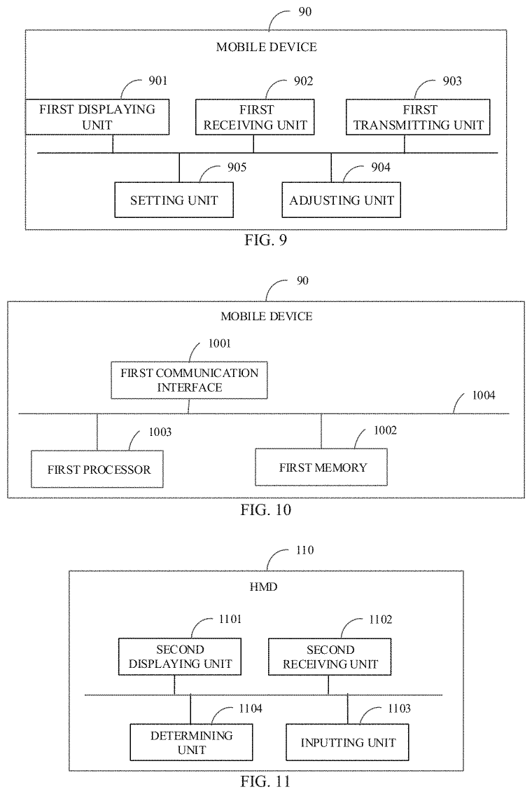

In yet another implementation of the present disclosure, based on the same inventive concept as the foregoing implementations, reference is made to FIG. 9, which is a schematic structural view of a mobile device 90 provided in implementations of the present disclosure. As illustrated in FIG. 9, the mobile device 90 includes a first displaying unit 901, a first receiving unit 902, and a first transmitting unit 903.

The first receiving unit 902 is configured to receive a first operation instruction at a keyboard area, where the mobile device has an operation interface, and the operation interface includes the keyboard area and a control area.

The first displaying unit 901 is configured to display at least one candidate text in the control area, the at least one candidate text being generated according to the first operation instruction.

The first receiving unit 902 is configured to receive a second operation instruction at the control area.

The first transmitting unit 903 is configured to determine a target text from the at least one candidate text, and transmit the target text to a text entry interface of an HMD, the target text being generated according to the second operation instruction.

In some implementations, the first displaying unit 901 is further configured to display, in a screen of the mobile device, the keyboard area in the left screen area and the control area in the right screen area.

As illustrated in FIG. 9, in some implementations, the mobile device further includes an adjusting unit 904. The adjusting unit 904 is configured to resize the left area and the right area according to a size of the screen of the mobile device and a size of a hand of a user.

In some implementations, the keyboard area includes a virtual keyboard, and the first receiving unit 902 is specifically configured to generate the at least one candidate text according to a first touch-and-slide operation, upon detecting the first touch-and-slide operation on the virtual keyboard performed by a finger of a user, where the first operation instruction is generated according to the first touch-and-slide operation on the virtual keyboard performed by the finger of the user.

In some implementations, the keyboard area is operable under multiple input modes, and the multiple input modes at least include a letter input mode and a word input mode. Correspondingly, the first receiving unit 902 is further configured to receive a third operation instruction at the control area; and the first displaying unit 901 is further configured to control, according to the third operation instruction, the keyboard area to switch among the multiple input modes.

In some implementations, the first displaying unit 901 is specifically configured to control the keyboard area to switch among the multiple input modes upon detecting a double-tap operation in the control area performed by the finger of the user.

In some implementations, the first displaying unit 901 is specifically configured to: when the input mode is a letter input mode, determine a key in the keyboard area selected by the finger of the user, upon detecting the first touch-and-slide operation on the virtual keyboard performed by the finger of the user; and display at least one candidate letter in the control area according to the key selected.

In some implementations, the first displaying unit 901 is further configured to highlight the key selected.

In some implementations, the first displaying unit 901 is specifically configured to: when the input mode is a word input mode, determine a slide path of the finger of the user in the keyboard area, upon detecting the first touch-and-slide operation on the virtual keyboard performed by the finger of the user; and display at least one candidate word in the control area according to the slide path.

In some implementations, the first displaying unit 901 is further configured to: determine to select at least one key, upon detecting in the slide path that a residence time of the finger of the user on the at least one key is longer than a first time; and generate the at least one candidate word according to a sequence of the at least one key in the slide path, and display the at least one candidate word in the control area.

In some implementations, the first displaying unit 901 is further configured to: determine that a key is repetitively selected, upon detecting in the slide path that a residence time of the finger of the user on the key is longer than a second time; or determine that the key is repetitively selected, upon detecting in the slide path that the finger of the user holds on the key and the finger of the user performs a tap operation in the control area, where the key is any key on the virtual keyboard.

In some implementations, the first displaying unit 901 is further configured to determine the target text from the at least one candidate text according to a slide direction of a second touch-and-slide operation, upon detecting the second touch-and-slide operation in the control area performed by a finger of a user, where the second operation instruction is generated according to the second touch-and-slide operation in the control area performed by the finger of the user.

In some implementations, the first receiving unit 902 is configured to receive a fourth operation instruction at the control area. The first displaying unit 901 is further configured to: control, according to the fourth operation instruction, the control area to switch display among multiple sets of candidate texts.

In some implementations, the control area includes a first button and a second button, and correspondingly the first displaying unit 901 is specifically configured to control the control area to switch display among the multiple sets of candidate texts upon detecting a tap operation on the first button or the second button in the control area performed by a finger of a user; where the first button is configured to trigger display of the at least one candidate text to be updated to a next set, and the second button is used to trigger display of the at least one candidate text to be updated to a previous set.

In some implementations, the first displaying unit 901 is further configured to control the control area to switch display among the multiple sets of candidate texts upon detecting a third touch-and-slide operation towards the first button or the second button in the control area performed by the finger of the user.

Reference is made to FIG. 9, and in some implementations, the mobile device 90 further includes a setting unit 905. The setting unit 905 is configured to set the at least one candidate text to a scrollable list; and the first displaying unit 901 is further configured to control a candidate text in the scrollable list to be scrolled and displayed according to a slide direction of a fourth touch-and-slide operation, upon detecting the fourth touch-and-slide operation in the control area performed by the finger of the user.

It can be understood that, in implementations of the present disclosure, a “unit” may be a part of a circuit, a part of a processor, a part of a program, or a part of software, etc., and the “unit”, of course, may also be a module, or non-modular. Moreover, each component in the implementation may be integrated into one processing unit, each unit may exist physically alone, or two or more units may be integrated into one unit. The above-mentioned integrated unit can be implemented in the form of hardware, or in the form of software function modules.

If the integrated unit is implemented in the form of a software functional module and is not sold or used as an independent product, the integrated unit can be stored in a computer-readable storage medium. Based on such understanding, essence of the technical solution of this implementation, a part that contributes to the prior art, or the whole or part of the technical solution can be embodied in the form of a software product. The computer software product is stored in a storage medium, and the computer software product includes several instructions which, when executed, causes a computer device (for example, a personal computer, a server, or a network device, etc.) or a processor to implement all or part of steps of the method described in implementations. The aforementioned storage medium includes: a U disk, a removable hard disk, a read only memory (ROM), a random access memory (RAM), a magnetic disk, an optical disk, or other media that can store program codes.

Therefore, a non-transitory computer storage medium is provided in implementations of the present disclosure. The computer storage medium is applicable to the mobile device 90 and stores a computer program which, when executed by a first processor, is operable to implement any of the methods in the forgoing implementations.

Based on the composition of the above mobile device 90 and the computer storage medium, reference is made to FIG. 10, which is a schematic diagram of a hardware structure of a mobile device provided in implementations of the present disclosure. As illustrated in FIG. 10, the mobile device 90 includes a first communication interface 1001, a first memory 1002, and a first processor 1003; and each component is coupled together through a first bus system 1004. It can be understood that the first bus system 1004 is configured to realize connection and communication between these components. In addition to a data bus, the first bus system 1004 also includes a power bus, a control bus, and a status signal bus. However, for the sake of clarity, various buses are designated as the first bus system 1004 in FIG. 10. The first communication interface 1001 is used for signal reception and signal transmission in the process of information reception and information transmission with other external network elements.

The first memory 1002 is configured to store a computer program running on the first processor 1003. The first processor 1003 is configured to execute the following when running the computer program: receiving a first operation instruction at the keyboard area; displaying at least one candidate text in the control area, the at least one candidate text being generated according to the first operation instruction; receiving a second operation instruction at the control area; and determining a target text from the at least one candidate text according to the second operation instruction, and transmitting the target text to a text entry interface of a HMD.

It can be understood that the first memory 1002 in this implementation of the present disclosure may be a transitory memory, a non-transitory memory, or may include both a transitory memory and a non-transitory memory. The non-transitory memory may be a read-only memory (ROM), a programmable ROM (PROM), an erasable PROM (EPROM), an electrically EPROM (EEPROM), or a flash memory. The transitory memory may be a random access memory (RAM) used as an external cache. Through illustrative description rather than restrictive, many forms of RAM are available, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), and a direct rambus RAM (DRRAM). The first memory 1002 in the system and method described herein is intended to include, but not be limited to, these and any other suitable forms of memories.

The first processor 1003 may be an integrated circuit chip with a signal processing capability. Each step of the above-mentioned method in an implementation process can be completed by an integrated logic circuit in the form of hardware or an instruction in the form of software in the first processor 1003. The first processor 1003 may be a general-purpose processor, a digital signal processor (DSP), an application specific integrated circuit (ASIC), a field programmable gate array (FPGA), or other programmable logic devices, discrete gates, transistor logic devices, or discrete hardware components, which can implement and execute each method, each step, and each logic block diagram disclosed in implementations of the present disclosure. The general-purpose processor may be a microprocessor, any conventional processor or the like. The steps of the method disclosed with reference to the implementations of the present disclosure may be directly embodied as executed by a hardware decoding processor, or executed by a combination of hardware and software modules in a decoding processor. The software module can be located in a RAM, a flash memory, an ROM, a PROM, an EEPROM, a register, and other storage media mature in the art. The storage medium is located in the first memory 1002, and the first processor 1003 is configured to read information in the first memory 1002 and complete the steps of the above methods in combination with hardware of the first processor 1003.

It can be understood that the implementations described herein may be implemented in hardware, software, firmware, middleware, microcode, or a combination thereof. For implementation in hardware, a processing unit may be implemented as at least one ASIC, at least one DSP, DSP Device (DSPD), at least one programmable logic device (PLD), at least one field-programmable gate array (FPGA), at least one general-purpose processor, at least one controller, microcontroller, at least one microprocessor, other electronic units for performing functions described in the present disclosure, or a combination thereof. For implementation in software, techniques described in the disclosure may be implemented through a module (e.g., a procedure, a function, etc.) that performs functions described in the disclosure. Software codes may be stored in a memory and executed by a processor. The memory can be implemented in the processor or external to the processor.

Optionally, as another implementation, the first processor 1003 is further configured to execute the method described in any of the foregoing implementations when running the computer program.

A mobile device is provided in the implementation, and the mobile device includes the first displaying unit, the first receiving unit, and the first transmitting unit. In this way, since text entry for the HMD is realized through the operation interface of the mobile device, and the operation interface of the mobile device is divided into the keyboard area and the control area, an input operation can be performed with both hands to improve a typing speed, and the user does not need to look at the mobile device while typing, which can not only reduce the need for the user to move his/her eyes to watch a screen of the mobile device when using the mobile device as a text entry device, but also improve a text entry efficiency.

In yet another implementation of the present disclosure, based on the same inventive concept as the previous implementations, reference is made to FIG. 11, which is a schematic structural view of an HMD 110 provided in implementations of the present disclosure. As illustrated in FIG. 11, the HMD 110 may include a second displaying unit 1101, a second receiving unit 1102, and an inputting unit 1103.

The second displaying unit 1101 is configured to display a text entry interface. The second receiving unit 1102 is configured to receive a target text transmitted by a mobile device. The inputting unit 1103 is configured to input the target text into the text entry interface.

In some implementations, the second displaying unit 1101 is further configured to display an operation interface of the mobile device; and correspondingly the second receiving unit 1102 is specifically configured to receive the target text transmitted by the mobile device according to a response of the mobile device to the operation interface.

In some implementations, the operation interface includes a keyboard area and a control area, the keyboard area includes a virtual keyboard, and correspondingly the second displaying unit 1101 is further configured to display the keyboard area and the control area in the HMD, and highlight a selected key on the virtual keyboard.

In some implementations, the second displaying unit 1101 is further configured to display a position of a finger of a user on the virtual keyboard with a preset indication.

In some implementations, reference is made to FIG, 11, and the HMD 110 may further include a determining unit 1104. The determining unit 1104 is configured to determine, according to at least one candidate text displayed in the control area, a slide direction of a finger of a user in the control area, where the slide direction indicates selecting a target text through a touch-and-slide operation on the operation interface of the mobile device performed by the finger of the user.

It can be understood that, in implementations of the present disclosure, a “unit” may be a part of a circuit, a part of a processor, a part of a program, or a part of software, etc., and the “unit”, of course, may also be a module, or non-modular. Moreover, each component in the implementation may be integrated into one processing unit, each unit may exist physically alone, or two or more units may be integrated into one unit. The above-mentioned integrated unit can be implemented in the form of hardware, or in the form of software function modules.

If the integrated unit is implemented in the form of a software functional module and is not sold or used as an independent product, the integrated unit can be stored in a computer-readable storage medium. Based on such understanding, a non-transitory computer storage medium is provided in this implementation, which is applicable to the HMD 110. The computer storage medium stores a computer program which, when executed by the second processor, is configured to implement any of the methods in the above-mentioned implementations.

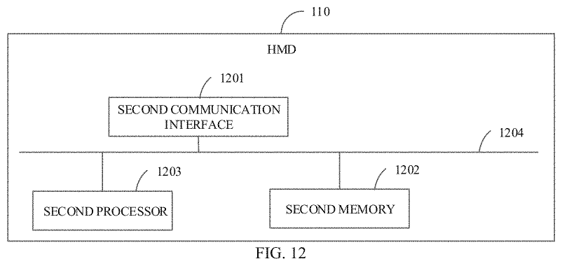

Based on composition of the above HMD 110 and the computer storage medium, reference is made to FIG. 12, which is a schematic diagram of a hardware structure of the HMD 110 provided in implementations of the present disclosure. As illustrated in FIG. 12, the HMD 110 may include a second communication interface 1201, a second memory 1202, and a second processor 1203; and each component is coupled together through a second bus system 1204. It can be understood that the second bus system 1204 is configured to realize connection and communication between these components. In addition to a data bus, the second bus system 1204 also includes a power bus, a control bus, and a status signal bus. However, for the sake of clarity, various buses are designated as the second bus system 1204 in FIG. 12. The second communication interface 1201 is used for signal reception and signal transmission in the process of information reception and information transmission with other external network element.

The second memory 1202 is configured to store a computer program executable on the second processor 1203. The second processor 1203 is configured to execute the following, when running the computer program: displaying a text entry interface; and receiving a target text transmitted by a mobile device and inputting the target text into the text entry interface.

Optionally, as another implementation, the second processor 1203 is further configured to execute the method described in any of the foregoing implementations when running the computer program.

It can be understood that the second memory 1202 is similar to the first memory 1002 in hardware functions, and the second processor 1203 is similar to the first processor 1003 in hardware functions, which will not be described in detail here.

The HMD is provided in implementations, and the HMD includes the second displaying unit, the second receiving unit, and the inputting unit. In this way, since text entry for the HMD is realized through the operation interface of the mobile device, and the operation interface of the mobile device is divided into the keyboard area and the control area, an input operation can be performed with both hands to improve a typing speed, and the user does not need to look at the mobile device while typing, which can not only reduce the need for the user to move his/her eyes to watch a screen of the mobile device when using the mobile device as a text entry device, but also improve a text entry efficiency.

It should be noted that, in the disclosure, the terms “comprising”, “including”, or any other variation thereof are intended to encompass non-exclusive inclusion, such that a process, a method, an article, or a device including a series of elements includes not only those elements, but also other elements not expressly listed or elements inherent to such a process, a method, an article, or a device. Without further limitation, an element limited by the phrase “comprising a . . . ” does not preclude existence of additional identical elements in a process, a method, an article, or a device that includes the element.

The serial numbers in the above-mentioned implementations of the present disclosure are only for illustrative rather than representing priorities of the implementations.

The methods disclosed in the several method implementations provided in this disclosure can be arbitrarily combined without conflict to obtain a new method implementation.

The features disclosed in the several product implementations provided in this disclosure can be combined arbitrarily without conflict to obtain a new product implementation.

The features disclosed in several method or device implementations provided in this disclosure can be combined arbitrarily without conflict to obtain a new method implementation or a device implementation.

The implementations described above are mere some implementations of the present disclosure, but should not be construed as a limitation on the scope of the present disclosure. Those skilled in the art may make changes or substitutions without departing from the concept of the present disclosure, all of which fall within the protection scope of the present disclosure. Therefore, the protection scope of the present disclosure shall be subject to the attached claims.

In implementations of the present disclosure, since the screen of the mobile device is divided into two parts, which are used to display the keyboard area and the control area and can be operated with both hands, it is convenient for the user to input texts on the HMD which is tethered to the mobile device. In the meanwhile, elements that the user are already familiar with are used in the operation interface of the mobile device, such as a multi-letter keyboard layout similar to the familiar T9 keyboard, and thus onboarding time of the user can be shortened. In this way, since text entry for the HMD is realized through the operation interface of the mobile device, which can not only reduce the need for the user to move his/her eyes to watch a screen of the mobile device when using the mobile device as a text entry device, but also improve a text entry efficiency.

What is claimed is:

1. A text entry method, performed by a mobile device having an operation interface, the operation interface comprising a keyboard area and a control area, and the method comprising:
receiving a first operation instruction at the keyboard area;
displaying at least one candidate text in the control area, the at least one candidate text being generated according to the first operation instruction;
receiving a second operation instruction at the control area; and
determining a target text from the at least one candidate text according to the second operation instruction, and transmitting the target text to a text entry interface of a head-mounted display (HMD) for display.

2. The method of claim 1, further comprising:
resizing the keyboard area and the control area according to a size of a screen of the mobile device and a size of a hand of a user.

3. The method of claim 1, wherein the keyboard area comprises a virtual keyboard, and receiving the first operation instruction at the keyboard area comprises:
detecting a touch-and-slide operation on the virtual keyboard performed by a finger of a user; and
generating the first operation instruction according to the touch-and-slide operation.

4. The method of claim 1, wherein the keyboard area is operable under a plurality of input modes, the plurality of input modes at least comprise a letter input mode and a word input mode, and the method further comprises:
receiving a third operation instruction at the control area; and
controlling, according to the third operation instruction, the keyboard area to switch among the plurality of input modes.

5. The method of claim 4, wherein receiving the third operation instruction at the control area comprises:
detecting a double-tap operation in the control area performed by a finger of a user; and
generating the third operation instruction according to the double-tap operation.

6. The method of claim 3, wherein the keyboard area is operable under a plurality of input modes, the plurality of input modes at least comprise a letter input mode and a word input mode, and the method further, and when the input mode is the letter input mode, displaying the at least one candidate text in the control area comprises:
determining a key in the keyboard area selected by the finger of the user, upon detecting the touch-and-slide operation on the virtual keyboard performed by the finger of the user; and
displaying at least one candidate letter in the control area according to the key selected.

7. The method of claim 6, further comprising:
highlighting the key selected.

8. The method of claim 3, wherein the keyboard area is operable under a plurality of input modes, the plurality of input modes at least comprise a letter input mode and a word input mode, and when the input mode is the word input mode, displaying the at least one candidate text in the control area comprises:
determining a slide path of the finger of the user in the keyboard area, upon detecting the touch-and-slide operation on the virtual keyboard performed by the finger of the user; and
displaying at least one candidate word in the control area according to the slide path.

9. The method of claim 8, wherein displaying the at least one candidate word in the control area according to the slide path comprises:
determining to select at least one key on the virtual keyboard, upon detecting in the slide path that a residence time of the finger of the user on the at least one key is longer than a first time; and
generating the at least one candidate word according to a sequence of the at least one key in the slide path, and displaying the at least one candidate word in the control area.

10. The method of claim 8, further comprising:
determining that a key on the virtual keyboard is repetitively selected, upon detecting in the slide path that a residence time of the finger of the user on the key is longer than a second time; or determining that the key is repetitively selected, upon detecting in the slide path that the finger of the user holds on the key and the finger of the user performs a tap operation in the control area.

11. The method of claim 1, wherein receiving the second operation instruction at the control area and determining the target text from the at least one candidate text comprises:
determining the target text from the at least one candidate text according to a slide direction of a touch-and-slide operation in the control area performed by a finger of a user, upon detecting the touch-and-slide operation, wherein the second operation instruction is generated according to the touch-and-slide operation in the control area performed by the finger of the user.

12. The method of claim 1, further comprising:
receiving a third operation instruction at the control area; and
controlling, according to the third operation instruction, the control area to switch display among a plurality of sets of candidate texts.

13. The method of claim 12, wherein the control area comprises a first button and a second button, and receiving the third operation instruction at the control area comprises:
detecting a tap operation on the first button or the second button in the control area performed by a finger of a user; and
generating the third operation instruction at the control area according to the tap operation;
wherein the first button is configured to trigger display of the at least one candidate text to be updated to a next set, and the second button is used to trigger display of the at least one candidate text to be updated to a previous set.

14. The method of claim 13, further comprising:
controlling the control area to switch display among the plurality of sets of candidate texts upon detecting a touch-and-slide operation towards the first button or the second button in the control area performed by the finger of the user.

15. The method of claim 1, further comprising:
setting the at least one candidate text to a scrollable list; and
controlling a candidate text in the scrollable list to be scrolled and displayed according to a slide direction of a touch-and-slide operation in the control area performed by the finger of a user, upon detecting the touch-and-slide operation.

16. A text entry method, performed by a head-mounted display (HMD) and comprising:
displaying a text entry interface; and
receiving a target text transmitted by a mobile device and inputting the target text into the text entry interface.

17. The method of claim 16, further comprising:
displaying an operation interface of the mobile device; and
receiving the target text transmitted by the mobile device comprises:
receiving the target text transmitted by the mobile device, the target text being generated according to a response of the mobile device to the operation interface.

18. The method of claim 17, wherein the operation interface comprises a keyboard area and a control area, the keyboard area comprises a virtual keyboard, and displaying the operation interface of the mobile device comprises:
displaying the keyboard area and the control area in the HMD, and highlighting a selected key on the virtual keyboard.

19. The method of claim 18, further comprising:
displaying a position of a finger of a user on the virtual keyboard with a preset indication.

20. A mobile device, comprising:
a first memory configured to store a computer program executable on a first processor;
wherein when the computer program is executed by the first processor, the first processor is configured to:
receive a first operation instruction at the keyboard area;
display at least one candidate text in the control area, the at least one candidate text being generated according to the first operation instruction;
receive a second operation instruction at the control area; and
determine a target text from the at least one candidate text according to the second operation instruction, and transmit the target text to a text entry interface of a head-mounted display (HMD) for display.
